(19) United States
(12) Patent Application Publication
(10) Pub. No.: US 2002/0188546 A1
(43) Pub. Date: Dec. 12, 2002

(54) Pricing delivery system

(76) Inventor: Cedric Tang, Beaconsfield (GB)

Correspondence Address: Clifford Chance Rogers & Wells LLP, 200 Park Avenue, New York, NY, 10166-0153, US

(21) Appl. No.: 09/843,124

(22) Filed: Apr. 26, 2001

(51) Int. Cl. G06F 17/60

(52) U.S. Cl. 705/37

(57) ABSTRACT

A system is provided for providing real-time financial information for OTC securities and includes a plurality of traders generating pricing information for the OTC securities. Also included is a plurality of regional pricing databases wherein each of the plurality of regional pricing databases receive the pricing information from some of the plurality of traders. An analytics tool engine in communications with the plurality of regional pricing databases for receiving the pricing information is included wherein the analytics tool engine generates a plurality of analytic views based on the pricing information. When at least one of the plurality of traders generates new pricing information updating the pricing information for at least one of the OTC securities, the analytics tool engine automatically updates at least one of the plurality of analytic views based on the new pricing information.

### BACKGROUND

The following invention relates to a system and method for providing financial information and, in particular, to a system and method for providing real-time financial information and analytics.

In order to make informed investment decisions, timely and accurate financial information regarding the particular investment is essential. Such financial information typically includes relevant news stories and research reports pertaining to the investment as well as real-time pricing information, historical pricing and analytic tools that may be used to identify key trends. Thus, access to such information is vital part of any successful investment strategy.

For certain financial products, real-time pricing information is readily available. For example, for financial products that trade through a centralized exchange, such as the New York Stock Exchange, the exchange typically aggregates in real-time the most recent transactions executed on the exchange for each security and makes such real-time pricing information available to its subscribers. The subscribers can then use the real-time information to analyze their portfolio, spot market trends and make informed investment decisions.

Many financial products, however, do not trade through a centralized exchange having a central book but are traded over-the-counter (“OTC”) in which case real-time pricing information and analytics is not readily available. In OTC markets, for example the FX derivatives market, an investor desiring a price quote contacts a broker at a financial institution who provides a price quote based on recent trades the broker performed and the financial institution's risk position. If the investor desires to trade at the price provided by the broker, the financial institution typically acts as a counterparty to the trade. The broker's price, however, may only reflect the price at which the broker will transact and may not accurately reflect the best price available in the market at that precise time. Thus, in the OTC markets, investors do not have access to real-time pricing information and analytic tools to help make informed investment decisions.

Accordingly, it is desirable to provide a system and method for providing real-time price information and analytics for over-the-counter financial products.

### SUMMARY OF THE INVENTION

The present invention is directed to overcoming the drawbacks of the prior art. Under the present invention a system is provided for providing real-time financial information for OTC securities and includes a plurality of traders generating pricing information for the OTC securities. Also included is a plurality of regional pricing databases wherein each of the plurality of regional pricing databases receive the pricing information from some of the plurality of traders. An analytics tool engine in communications with the plurality of regional pricing databases for receiving the pricing information is included wherein the analytics tool engine generates a plurality of analytic views based on the pricing information. When at least one of the plurality of traders generates new pricing information updating the pricing information for at least one of the OTC securities, the analytics tool engine automatically updates at least one of the plurality of analytic views based on the new pricing information.

In an exemplary embodiment, the pricing information is received by the analytics tool engine in real-time.

In another exemplary embodiment, an historical pricing database is included wherein when the new pricing information updating the pricing information for the at least one of said OTC securities is received, the pricing information for the at least one of said OTC securities is stored in the historical pricing database.

In yet another exemplary embodiment, the OTC securities includes foreign exchange derivatives.

In still yet another exemplary embodiment, the plurality of regional databases includes three regional databases and wherein each of the three regional databases are located in a different trading time zone.

In an exemplary embodiment, the pricing information includes volatility surfaces, FX spot rates and short term interest rates.

In another exemplary embodiment, a global pricing manager is included and receives notification from at least one of the plurality of regional databases that one of the plurality of traders generated the new pricing information. The global pricing manager then receives the new pricing information from the at least one of said plurality of regional databases.

In yet another exemplary embodiment, an analytics view manager in communications with the global pricing manager and the analytics tool manager is included. The analytics view manager receives a notification of the new pricing information from the global pricing manager and determines whether the new pricing information is relevant to at least one of the plurality of views.

In still yet another exemplary embodiment, the analytics view manager receives the new pricing information from the global pricing manager and forwards the new pricing information to the analytics tool manager.

In an exemplary embodiment, at least one access device in communications with the analytics tools manager is included wherein the access device displays at least one of the plurality of views. When the analytics tool engine receives the new pricing information, the analytics tools engine automatically updates the display of the at least one of said plurality of analytic views.

In yet another exemplary embodiment, the plurality of analytic views includes a volatility view, a smile view, a GARCH view, a HiLoView, a SpreadView, a Rich-Cheap Implied view, a Rich-Cheap Implied over Actual view, a Risk Reversal Value view, a Butterfly Value view and/or a Forecast Range view.

Under the present invention, a method is provided for providing real-time financial information for OTC securities and includes the step of receiving pricing information for the OTC securities from a plurality of traders. Next, a plurality of analytic views based on the pricing information is generated. Next, new pricing information updating the pricing information for at least one of the OTC securities is received from at least one of the plurality of traders. Finally, at least one of said analytic views is automatically updated based on the new pricing information.

Accordingly, a system and method for providing real-time price information and analytics for over-the-counter financial products.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is block diagram of the pricing delivery system of the present invention;

FIG. 2 is screenshot of a view that displays a consolidated overview of the volatility market for selectable currency pairs;

FIG. 3 is a screenshot of a view that displays the current volatility smiles for different expiries together with volatility smiles for the previous day, week and month; and

FIG. 4 is a screenshot of a view that displays a GARCH forecast.

### DETAILED DESCRIPTION OF THE PREFERRED EMBODIMENTS

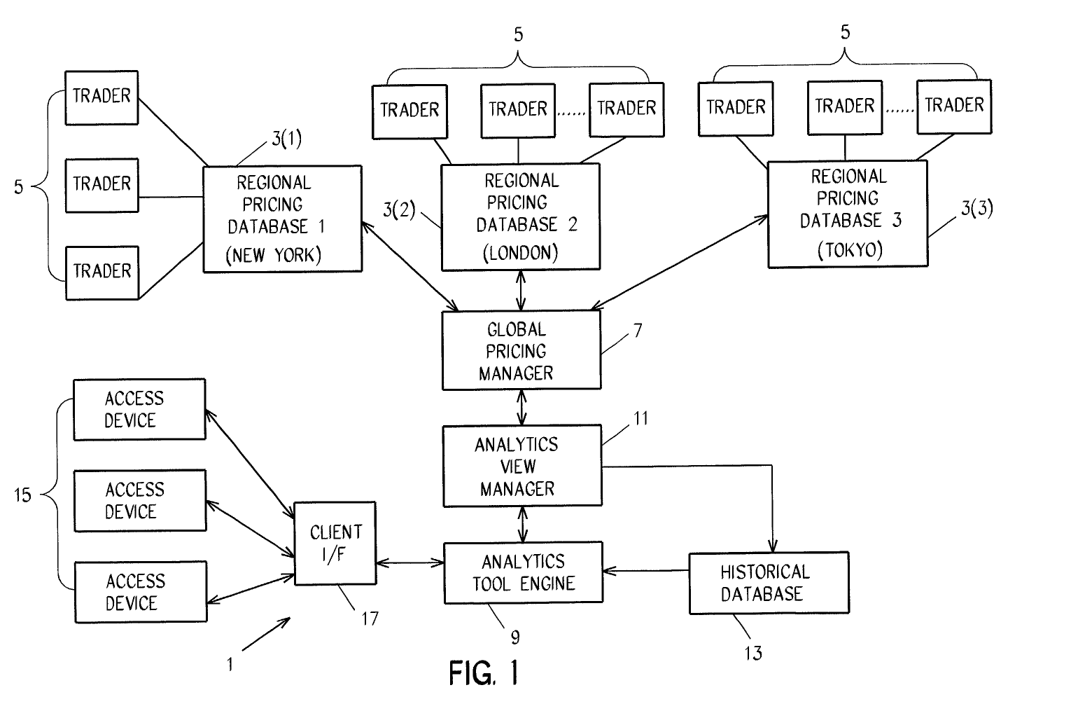

Referring now to FIG. 1, there is shown a block diagram of a pricing delivery system 1 of the present invention. Because OTC products do not trade in a centralized market like other financial products, such as equities, delivery system 1 enables a financial institution to provide investors with pricing for OTC products. To meet investor demands for accurate real-time pricing, pricing delivery system 1 must be able to provide pricing regardless of geographic location and time zone. Thus, pricing delivery system 1 includes a plurality of regional pricing databases 3 that each aggregate OTC pricing information in a different region of the world. In an exemplary embodiment, pricing delivery system 1 includes a regional pricing database 3(1) located in New York, a regional pricing database 3(2) located in London and a regional pricing database 3(3) located in Tokyo. In communications with each of regional databases 3 are a plurality of traders 5 that generate OTC pricing information that are received by one of regional database 3. During active trading hours in, for example, New York, those of traders 5 that are in communications with regional database 3(1) will generate pricing information and price updates in response to request from their clients. During this time, regional database 3(1) receives the pricing information provided by this group of traders 5. Similarly, during active trading hours in Tokyo, those of traders 5 that are in communications with regional database 3(3) generate pricing information in response to client requests. During this trading period, regional database 3(3) the pricing information from this group of traders 5. The same occurs with respect to regional database 3(2) during active trading hours in London.

Although the above embodiment includes three regional database, it will be obvious based on the description above to include more than three regional databases to aggregate pricing information for different trading time zones around the world. Also, it is possible that the active trading hours associated with two or more of regional databases 3 may overlap. In such a case, those of traders 5 communicating with each of the two or more of regional databases 3 provide pricing information to the respective one of the two or more of regional databases 3.

In summary, by placing regional databases 3 in different parts of the world, pricing information generated by traders throughout the world are received by regional databases 3. Also, as the number of traders 5 generating pricing information in system 1 increases, the more the pricing information aggregated by regional databases 3 reflects the real-time status of the particular OTC market. In an exemplary embodiment, at least one trader is provided per major currency per region per time zone. In this way, worldwide OTC pricing information are aggregated by system 1 in real-time.

The pricing information provided by traders 5 depend on the type of OTC product being priced. For example, for FX options, traders 5 generate volatility curves, using well-known techniques, which embody a particular one of traders' 5 position in the FX option market. As the particular one of traders' 5 position changes, the particular one of traders 5 may generate a price update that updates the previously generated volatility curve. Similarly, traders 5 may provide other types of pricing information including, but not limited to, spot prices.

Pricing delivery system 1 also includes a global pricing manager 7 that aggregates the pricing information from regional databases 3. Whenever new pricing information is received by any of regional pricing databases 3 from traders 5, the one of regional databases 3 notifies global pricing manager 3 that new pricing information has been received and is available. Global pricing manager 3 may then request from the one of regional databases 3 the new pricing information, as described below.

An objective of pricing delivery system 1 is to provide an investor with real-time price information and analytics for OTC products. Accordingly, pricing delivery system 1 includes an analytics tool engine 9 that receives pricing information and generates a plurality of analytic views based on such information. When global pricing manager 7 is notified by one of regional databases 3 that new pricing information has been received, global pricing manager 7 notifies an analytics view manager 11. Analytics view manager 11, which is in communications with analytics tool manager 9, first determines whether the new pricing information is relevant for updating any of the plurality of analytic views generated by analytics tool engine 9. If any such information is relevant, then analytics view manager 11 requests such relevant price information from global pricing manager 7. If global pricing manager 7 has the requested information already stored, then global pricing manager 7 provides the information to analytics view manager 11. If global pricing manager 7 does not have the requested information stored, then global pricing manager 7 requests the information from the one of regional databases 3 that have the requested information stored therein. Upon receipt of the requested information, global pricing manager 7 then forwards the pricing information to analytics view manager 11. Analytics view manager 11 then forwards the pricing information to analytics tool engine 9. Accordingly, new price information generated by any of traders 5 may be received by analytics tools engine 9 in real-time.

In addition to providing analytics tool engine 9 with the pricing information that is relevant to update the plurality of analytic views in real-time, analytics tool engine 9 also stores the past pricing information in an historic pricing database 13. Whenever analytics view manager 11 receives new pricing information, the previously received pricing information is then added by analytics view manager 11 to the past pricing information stored in historic pricing database 13. Thus, historic pricing database 13 maintains an ongoing sequence of historical price information for the OTC products serviced by system 1.

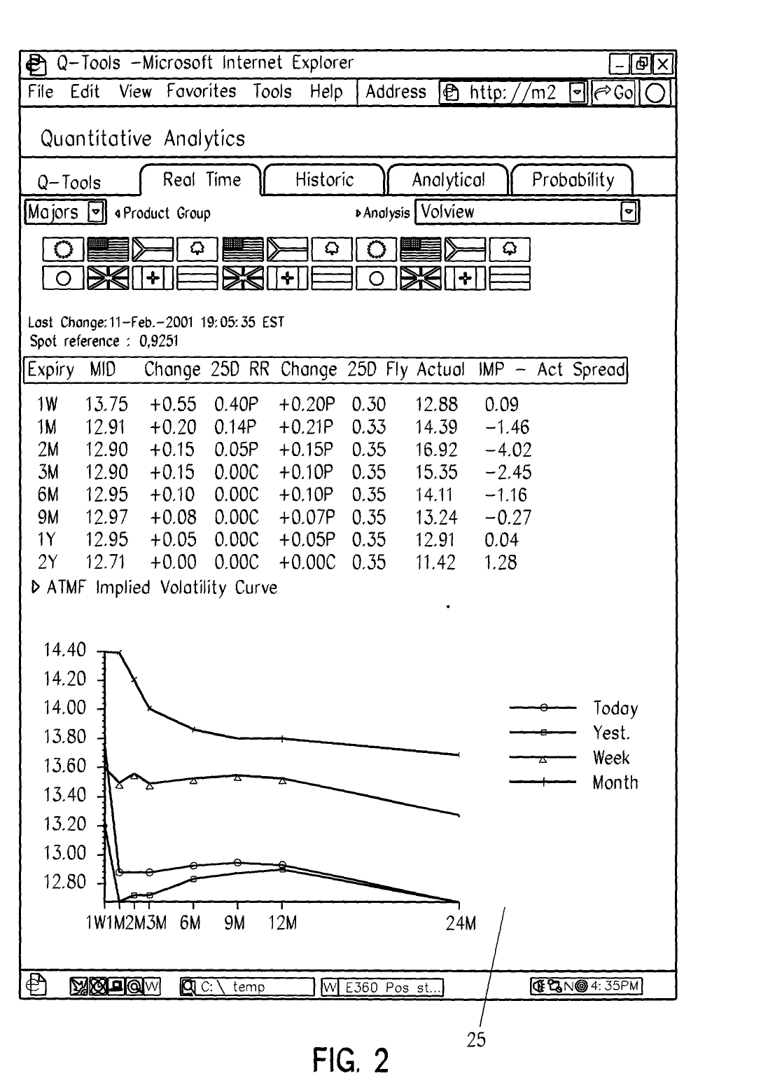

Analytics tool engine 9 generates the plurality of views based on the real-time pricing information received from analytics view manager 11 as well as the historical pricing information maintained by historical pricing database 13. The plurality of views generated by analytics tool engine 9 may include any type of analytic calculations and graphs for any type of OTC product. Referring now to FIG. 2, there is shown an exemplary view that displays a consolidated overview of the volatility market for selectable currency pairs. To display this view, analytics tools engine 9 receives the latest volatility surfaces and spot prices, in the manner described above. Based on this information and the historic pricing information contained in historic pricing database 13, analytics tool engine 9 uses well-known techniques to generate a series of volatility curves 25 including, by way of non-limiting example, curves of the history of the actual volatility, the implied volatility, the 25 delta risk reversals, the 25 delta butterflies and the implied over actual volatility spread.

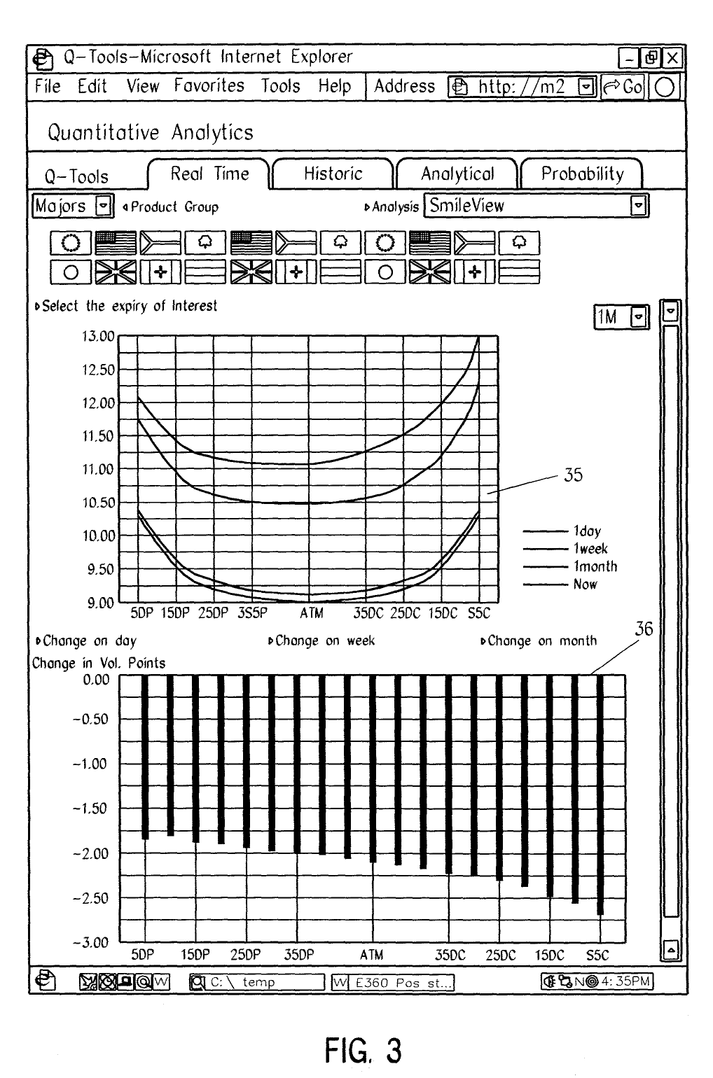

Referring now to FIG. 3, there is shown an exemplary view that displays a series of volatility smiles 35 for different expiries, together with volatility smiles for the previous day, week and month as well as a graph 36 showing the difference between the volatility smiles. Analytics tool engine 9 uses well-known techniques to calculate the volatility smiles based on the current volatility surfaces generated by traders 5, as well as the historical volatility surface contained in historical pricing database 13.

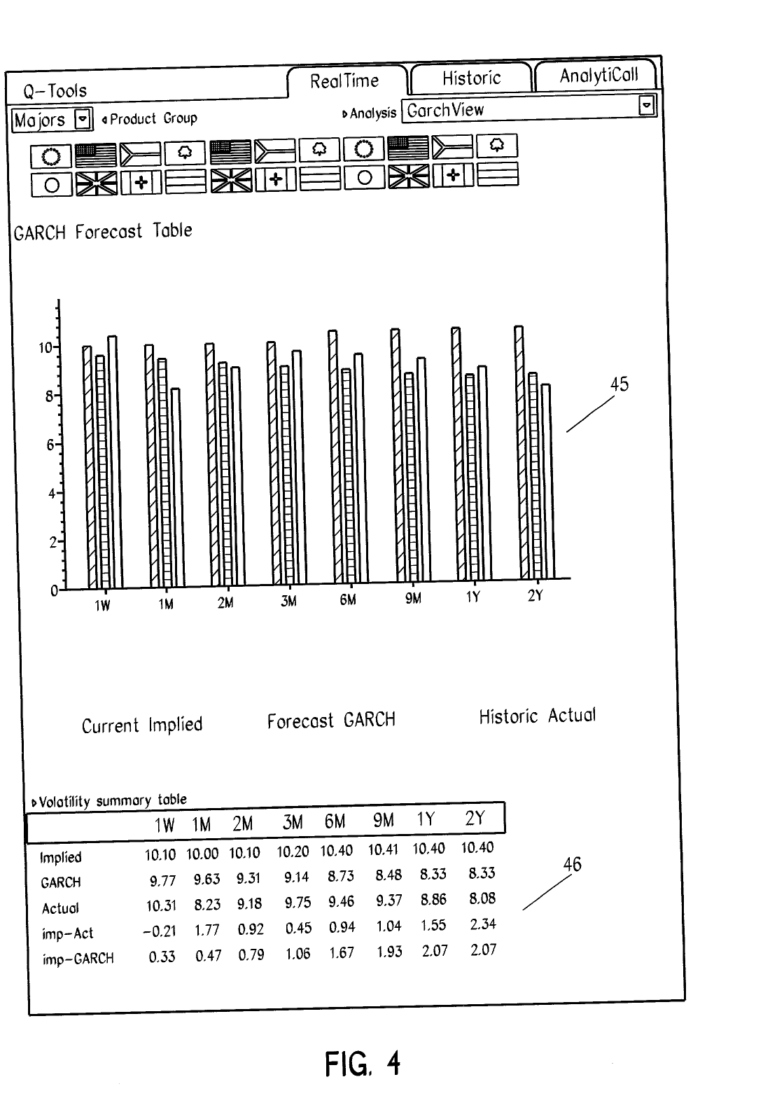

Referring now to FIG. 4, there is shown an exemplary view that displays a GARCH forecast 45 and a volatility summary table 46 that is calculated by analytics tool manager 9 using a GARCH (1,1) model, as is well-known.

In addition to the above analytic views, analytics tool manager may generate any other analytic views including, by way of non-limiting example, a HiLoView, a SpreadView, a Rich-Cheap Implied view, a Rich-Cheap Implied over Actual view, a Risk Reversal Value view, a Butterfly Value view and a Forecast Range view.

A client operating an access device 15, such as, by way of non-limiting example, a personal computer, interfaces with a user interface 17 to request any of the plurality of views generated by analytics tool engine 9. Upon receiving the request, analytics tool engine 9 provides the desired view to the client via user interface 17 which is then displayed for the client by access device 15.

The analytic views described above are real-time views—i.e., these views are automatically updated in real-time by analytics tool engine 9 with each update to pricing information generated by traders 5 that is relevant to the particular view. Furthermore, if a particular view is being displayed by access device 15, analytics tool engine 9 causes the particular view to be redrawn to reflect the updated pricing information. Thus, pricing delivery system 1 provides the client with pricing information and analytic views that are automatically updated in real-time.

In addition to the real-time analytic views described above, analytics tools engine 9 may provide the client with a plurality of historical views that are calculated at the client's request and according to the client's specification and are based on the historical pricing information contained in historical pricing database 13. Table 1 below list examples of such views and the type of pricing information required for generating such views.

TABLE 1

| VIEW | REQUIREMENT |
|---|---|
| Spot History | requires spot over the time period to be displayed |
| Implied and Actual Volatility History | requires implied volatility (“at the money”) for the time |
| | period to be displayed, and requires spot for a slightly |
| | longer period (to calculate the actual volatilities) |
| High Low Volatility Analysis | requires implied volatility (“at the money”) for the time |
| | period to be displayed, and requires spot for a slightly |
| | longer period (to calculate the actual volatilities) |
| 25-Delta Risk Reversal | requires the 25-delta implied volatility for the time |
| | period to be displayed. |
| 25-Delta Butterfly | requires the 25-delta and the ATM implied volatility for |
| | the time period to be displayed. |
| 25-Delta Strangle | requires the 25-delta and the ATM implied volatility for |
| | the time period to be displayed. |
| ATMF Curve History | requires the ATM implied volatility for the time period |
| | to be displayed. |
| Rich/Cheap Implied Vol Value Analysis | requires the ATM implied volatility for the time period |
| | to be displayed. |
| Vol of Implied Vol | requires the ATM implied volatility for slightly longer |
| | than the time period to be displayed (in order to |
| | calculate the actual volatility) |
| Implied over Actual Vol Spread | requires implied volatility (“at the money”) for the time |
| | period to be displayed, and requires spot for a slightly |
| | longer period (to calculate the actual volatilities) |
| Implied Vol Spread | requires the ATM implied volatility for the time period |
| | to be displayed, and also, if plotting against another |
| | currency pair, we need the ATM implied volatility |
| | history for that too. |
| Spot and Vol Correlation | requires implied volatility (“at the money”) for the time |
| | period to be displayed, and requires spot for a slightly |
| | longer period (to calculate the actual volatilities) |
| VolWatch | requires implied volatility (“at the money”) for the time |
| | period to be displayed, and requires spot for a slightly |
| | longer period (to calculate the actual volatilities) |
| DMACO Spot System | requires spot over the time period to be displayed |
| Spot Momentum | requires spot over the time period to be displayed |
| Relative Strength Index | requires spot over the time period to be displayed |
| Bollinger Bands | requires spot over the time period to be displayed |
| MACD | requires spot over the time period to be displayed |

In addition, to the historical views described above, analytics tool engine 9 may also provide the client with a plurality of probability views that are calculated on a periodic basis, and involves calculating various probabilities assuming risk-neutrality and the distribution implied by the implied volatility prices. These views include, by way of non-limiting example, Spot Ranges, Hit Odds, Hit Levels, Spot Odds, Spot ends down and Spot end up.

Based on the above description, it will be obvious to one of ordinary skill to implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention. In addition, it will be obvious to one of ordinary skill to use a conventional database management system such as, by way of non-limiting example, Sybase, Oracle and DB2, as a platform for implementing the present invention.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A system for providing real-time financial information for OTC securities, comprising:
a plurality of traders generating pricing information for said OTC securities;
a plurality of regional pricing databases, each of said plurality of regional pricing databases receiving said pricing information from some of said plurality of traders; and
an analytics tool engine being in communications with said plurality of regional pricing databases for receiving said pricing information, said analytics tool engine generating a plurality of analytic views based on said pricing information;
wherein when at least one of said plurality of traders generates new pricing information updating said pricing information for at least one of said OTC securities, said analytics tool engine automatically updates at least one of said plurality of analytic views based on said new pricing information.

2. The system of claim 1, wherein said pricing information is received by said analytics tool engine in real-time.

3. The system of claim 1, further comprising an historical pricing database, wherein when said new pricing information updating said pricing information for said at least one of said OTC securities is received, said pricing information for said at least one of said OTC securities is stored in said historical pricing database.

4. The system of claim 1, wherein said OTC securities includes foreign exchange derivatives.

5. The system of claim 1, wherein said plurality of regional databases includes three regional databases and wherein each of said three regional databases are located in a different trading time zone.

6. The system of claim 1, wherein said pricing information includes volatility surfaces.

7. The system of claim 1, wherein said pricing information includes spot prices.

8. The system of claim 2, further comprising a global pricing manager, said global pricing manager receiving notification from at least one of said plurality of regional databases that one of said plurality of traders generated said new pricing information and wherein said global pricing manager receives said new pricing information from said at least one of said plurality of regional databases.

9. The system of claim 8, further comprising an analytics view manager in communications with said global pricing manager and said analytics tool manager, said analytics view manager receives a notification of said new pricing information from said global pricing manager and determines whether said new pricing information is relevant to at least one of said plurality of views.

10. The system of claim 9, wherein said analytics view manager receives said new pricing information from said global pricing manager and forwards said new pricing information to said analytics tool manager.

11. The system of claim 1, further comprising at least one access device in communications with said analytics tools manager, said access device displaying at least one of said plurality of views, wherein when said analytics tool engine receives said new pricing information, said analytics tools engine automatically updates said display of said at least one of said plurality of analytic views.

12. The system of claim 1, wherein said plurality of analytic views includes a volatility view.

13. The system of claim 1, wherein said plurality of analytic views includes a smile view.

14. The system of claim 1, wherein said plurality of analytic views includes a GARCH view.

15. The system of claim 1, wherein said plurality of analytic views include any of the group including a HiLoView, a SpreadView, a Rich-Cheap Implied view, a Rich-Cheap Implied over Actual view, a Risk Reversal Value view, a Butterfly Value view and a Forecast Range view.

16. A method for providing real-time financial information for OTC securities, comprising the steps of:
receiving pricing information for said OTC securities from a plurality of traders;
generating a plurality of analytic views based on said pricing information;
receiving from at least one of said plurality of traders new pricing information updating said pricing information for at least one of said OTC securities; and
automatically updating at least one of said analytic views based on said new pricing information.

17. The method of claim 16, wherein said price update is received in real-time.

18. The method of claim 16, further comprising the step of:
storing in an historical pricing database said pricing information for said at least one of said OTC securities when said new pricing information updating said pricing information for said at least one of said OTC securities is received.

19. The method of claim 16, wherein said OTC securities includes foreign exchange derivatives.

20. The method of claim 16, wherein said pricing information includes volatility surfaces.

21. The method of claim 16, wherein said pricing information includes spot prices.

22. The method of claim 16, further comprising at least one access device displaying at least one of said plurality of views, wherein the step of automatically updating includes the step of:
automatically updating the display of said at least one of said plurality of analytic views.

23. The method of claim 16, wherein said plurality of analytic views includes a volatility view.

24. The method of claim 16, wherein said plurality of analytic views includes a smile view.

25. The method of claim 16, wherein said plurality of analytic views includes a GARCH view.

26. The method of claim 16, wherein said plurality of analytic views include any of the group including a HiLoView, a SpreadView, a Rich-Cheap Implied view, a Rich-Cheap Implied over Actual view, a Risk Reversal Value view, a Butterfly Value view and a Forecast Range view.
